(19) United States
(12) Patent Application Publication
(10) Pub. No.: US 2025/0093194 A1
(43) Pub. Date: Mar. 20, 2025

(54) MEASURING LIQUID LEVELS USING AN INCLINOMETER

(71) Applicant: Saudi Arabian Oil Company, Dhahran (SA)

(72) Inventors: Basil Saeed Abuhadi, Dhahran (SA); Mohannad Abdullah Othman, Dhahran (SA)

(21) Appl. No.: 18/471,068

(22) Filed: Sep. 20, 2023

(51) Int. Cl. G01F 23/36; G01C 9/02; G05D 9/12

(52) U.S. Cl. CPC G01F 23/36; G01C 9/02; G05D 9/12

(57) ABSTRACT

Systems for measuring liquid levels in a tank can include a lever arm pivotably attached to an inner wall of the tank at a first end of the lever arm. A float is mounted on the lever arm at a location spaced apart from the first end of the lever arm. An inclinometer is mounted on a lever arm to measure an angle of the lever arm relative to horizontal. A processor is operable to calculate a height of a surface of the fluid in the container based on the angle of the lever arm relative to horizontal.

### TECHNICAL FIELD

The present disclosure generally relates to measuring liquid levels in containers, particularly using an inclinometer.

### BACKGROUND

Inclinometers are sensors used to measure the magnitude of slope, tilt, elevation, or depression of an object with respect to the gravity. The tilt indicator sensors are of various types and sizes.

Level sensors detect the level of liquids and other fluids and fluidized solids that have an upper free surface. These sensors include vibrating, rotating paddle, diaphragm, capacitance, optical, nuclear, and ultrasonic level sensors. Applications include sensing levels in tanks and vessels containing fluids.

### SUMMARY

This specification describes systems and methods for measuring liquid levels in containers such as tanks and vessels (e.g., tanks used to store oil and gas). Measurements of liquid levels can be used to calculate volumes of different fluids (e.g., containers for injection chemicals such as demulsifiers, corrosion inhibitors, and other catalysts and water tanks). These systems and methods use an inclinometer mounted on a lever arm pivotably attached to an inner wall of a container. A float is mounted on the lever arm at a location spaced apart from the end of the lever arm attached to the wall of the container.

The systems and methods described in the specification are easy to implement, to maintain, and to replace. The components of the systems are relatively inexpensive compared to systems incorporating vibrating, rotating paddle, diaphragm, capacitance, optical, nuclear, and ultrasonic level sensors. In addition, this approach avoids the environmental impact of other systems (e.g., radioactive emissions and waste associated with nuclear sensors and ultrasonic emissions from ultrasound sensors which can disturb nearby wildlife.

### EXAMPLES

In some implementations, systems for measuring liquid levels in a tank include: a lever arm pivotably attached to an inner wall of the tank at a first end of the lever arm; a float mounted on the lever arm at a location spaced apart from the first end of the lever arm; an inclinometer mounted on a lever arm to measure an angle of the lever arm relative to horizontal; and a processor operable to calculate a height of a surface of the fluid in the container based on the angle of the lever arm relative to horizontal.

In an example implementation combinable with any other example implementations, the float is mounted on a second end of the lever arm opposite the first end of the lever arm.

In an example implementation combinable with any other example implementations, the system also includes a hinge attaching the lever arm to the inner wall of the container.

In an example implementation combinable with any other example implementations, the lever arm includes copper.

In an example implementation combinable with any other example implementations, the lever arm has a length between 50% and 100% of a height of the tank. In some cases, the lever arm is attached to the inner wall of the tank at half the height of the tank.

In an example implementation combinable with any other example implementations, the float is configured to float on the surface of oil. In some cases, the float has a density between 1 and 790 kilograms/square meter (kg/m²). Alternatively, in an example implementation combinable with any other example implementations, the float is configured to float at an interface between oil and water. In some cases, the float has a density between 790 and 1000 kilograms/square meter (kg/m²).

In an example implementation combinable with any other example implementations, the float is one of a plurality of floats having different densities and the floats are removably attached to the lever arm.

In an example implementation combinable with any other example implementations, the processor is operable to calculate a height (Hₛ) of the float in the tank based on the angle of the lever arm using the equation Hₛ=Hₚ−(Lₐ×sin θ) where Hₚ is the height at which the lever arm is attached to the tank, Lₐ is a length of the lever arm, and θ is the angle of the lever arm relative to horizontal.

In an example implementation combinable with any other example implementations, the system also includes a Supervisory Control and Data Acquisition (SCADA) system in electronic communication with the inclinometer. In some cases the processor is part of the SCADA system. In some cases, the SCADA system is operable to control at least one pump associated with the tank.

In an example implementation combinable with any other example implementations, the lever arm is one of a plurality of lever arms pivotably attached to the inner wall of the tank and the float is one of a plurality of floats, each float mounted on one of the plurality of lever arms, and the inclinometer is one of a plurality of inclinometers.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of a system for measuring the level of a fluid in a container.

FIG. 2 is a schematic view of the system of FIG. 1 being used in a tank that contains three fluids with different densities and measuring the level of the interface level between two of the fluids.

FIG. 3 is a schematic view of the system of FIG. 1 being used in a tank that contains three fluids with different densities.

FIG. 4 illustrates how the presence of sediments can introduce error into level measurements using the system of FIG. 1.

FIG. 5 illustrates hydrocarbon production operations that include both field operations and computational operations, which exchange information and control the production of hydrocarbons.

Like reference symbols in the various drawings indicate like elements.

### DETAILED DESCRIPTION

This specification describes systems and methods for measuring liquid levels in containers such as tanks and vessels (e.g., tanks used to store oil and gas). Measurements of liquid levels can be used to calculate volumes of different fluids. These systems and methods use an inclinometer mounted on a lever arm pivotably attached to an inner wall of a container. A float is mounted on the lever arm at a location spaced apart from the end of the lever arm attached to the wall of the container. The angle measured by the inclinometer is used to calculate the position of the fluid surface in the container.

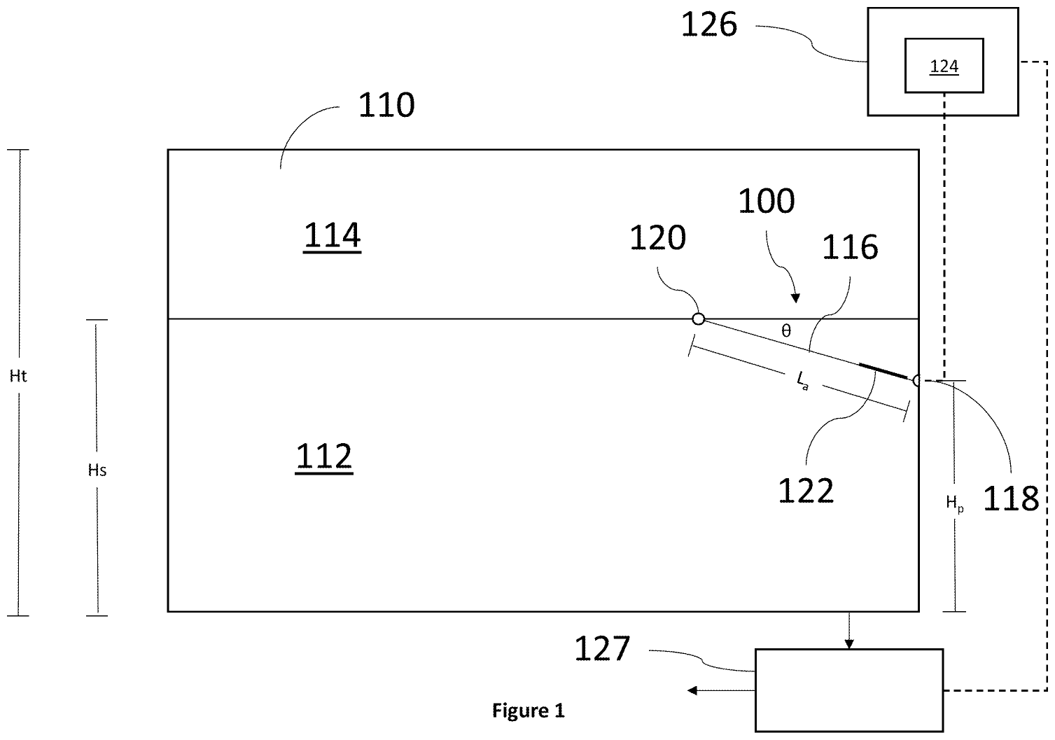

FIG. 1 is a schematic view of a system 100 for measuring the level of a fluid in a container 110 (e.g., a tank or storage vessel). As illustrated, the container 110 is filled with two fluids 112, 114 that are immiscible and have different densities. When the container 110 is undisturbed, the lighter fluid 114 separates from and floats on top of the heavier fluid 112. For example, when a fluid containing both oil and natural gas is pumped into a storage tank and allowed to settle, the oil and natural gas will separate with the natural gas rising above the oil.

The system 100 includes a lever arm 116 pivotably attached to an inner wall of the container 110. In the illustrated system 100, a hinge mounted by welding or bolts 118 attaches the lever arm 116 to the inner wall of the container 100. A float 120 is mounted on the lever arm 116 at a location spaced apart from the end of the lever arm 116 attached to the wall of the container 110. In the illustrated system 100, the float 120 is positioned at the end of the lever arm 116 opposite the end of the lever arm 116 attached to the wall. The lever arm 116 is made of a light, durable material that is resistant to mechanical damage during movement of the lever arm and/or chemical damage due to interactions with fluids in the tank 110. The illustrated lever arm is formed of a material whose density is greater than the density of the heavier fluid 112 so it will not contribute to making the lever arm float more than required. The illustrated level arm is made of copper. In some implementations, the lever arm 116 is made of other materials (e.g., wood or aluminum).

The length (Lₐ) of the lever arm 116 and the height (Hₚ) of the pivot (i.e., the hinge 118) determine the range of heights (Hₛ) of the surface that can be measured. In the illustrated system 100, the length Lₐ of the lever arm is half the height (Hₜ) of the tank and the height Hₚ of the pivot is also half the height Hₜ of the tank 110. This configuration allows the system 100 to measure the full range of possible surfaces in the tank 110 (i.e., from empty to full).

The float 120 is configured to float on the surface of the liquid whose height Hₛ in the tank 110 is being measured. In particular, the float 120 should have a density that is less than the density of the fluid on which it is designed for to float (e.g., fluid 112). If another fluid (e.g. fluid 114) is present that is lighter than the fluid on which the float 120 is designed to float, the density of the float 120 should be less than the density of the lighter fluid. For example, if the fluid 112 was oil and the fluid 114 was natural gas, the density of the float 120 should be between 1 and 790 kilograms/square meter (kg/m²). In another example, if the fluid 112 was water and the fluid 114 was oil, the density of the float 120 should be between 790 and 1000 kg/m². In some implementations, the float 120 and/or lever arm are changeable to allow the system to measure different interface levels between two liquids with different densities.

The relevant density of the float 120 is the overall density of the float. The illustrated float 120 is an inflatable ball that can be filled with air or other fluids to provide the desired density. Some floats are made of a single material of the desired density rather than having a cavity that can be filled. For example, a float made of Styrofoam® closed-cell extruded polystyrene foam would have a density of 50 kg/m² and would be appropriate to track the surface between oil or water and a gas. The float 120 is sized to be large enough to provide enough buoyancy to support the lever arm 116 and an inclinometer 122 mounted on the lever arm.

The inclinometer 122 is mounted on the lever arm 116 and measures the angle θ between the lever arm 116 and the liquid surface being tracked. In the illustrated system 100, the angle θ measured by the inclinometer 122 is transmitted to the processor 124 of a Supervisory Control and Data Acquisition (SCADA) system 126 associated with the tank 110. The processor 124 of the SCADA system 126 calculates the height of the surface (Hₛ) can be calculated using the equation

$${H}_{s} = {H}_{p} - ( {L}_{a} \times sin θ )$$

The SCADA system 126 can use the calculated height of the surface (HS), for example, to calculate the volume of specific fluids in the tank, as an input for making control decisions (e.g., operating pumps 127 associated with the tank 110), and/or knowing the reserved storage of available fluid. In some implementations, a local processor 124 is incorporated in the inclinometer 122 and the inclinometer 122 transmits the height of the surface rather than an angle to the SCADA system. Some systems 100, alternatively or additionally, include a local display indicating the height Hₛ of the tracked surface in the tank 110.

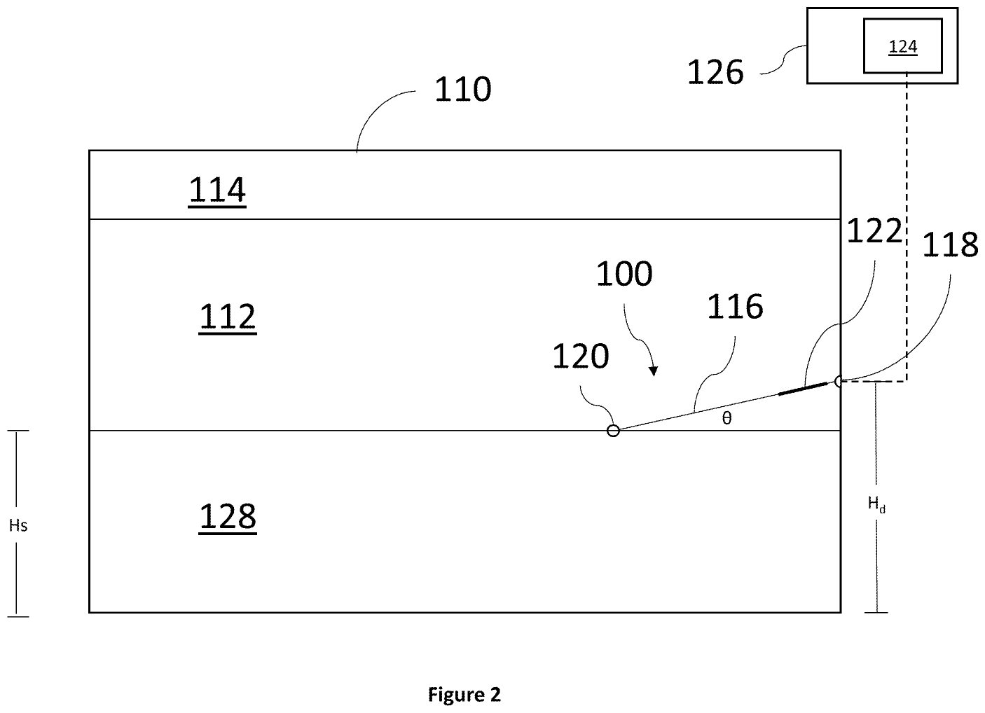

FIG. 2 is a schematic view of an implementation of the system 100 being used in a tank 110 that contains three fluids 112, 114, 128 with different densities. For example, this situation could occur water 128, oil 112, and natural gas 114 are present in a fluid stored in the tank 110. In the illustrated implementation, the system 100 is configured to track the boundary between water 128 and the oil 112. Accordingly, the density of the float 120 should be between 790 and 1000 kg/m². Various non-metallic floats could be used in this case.

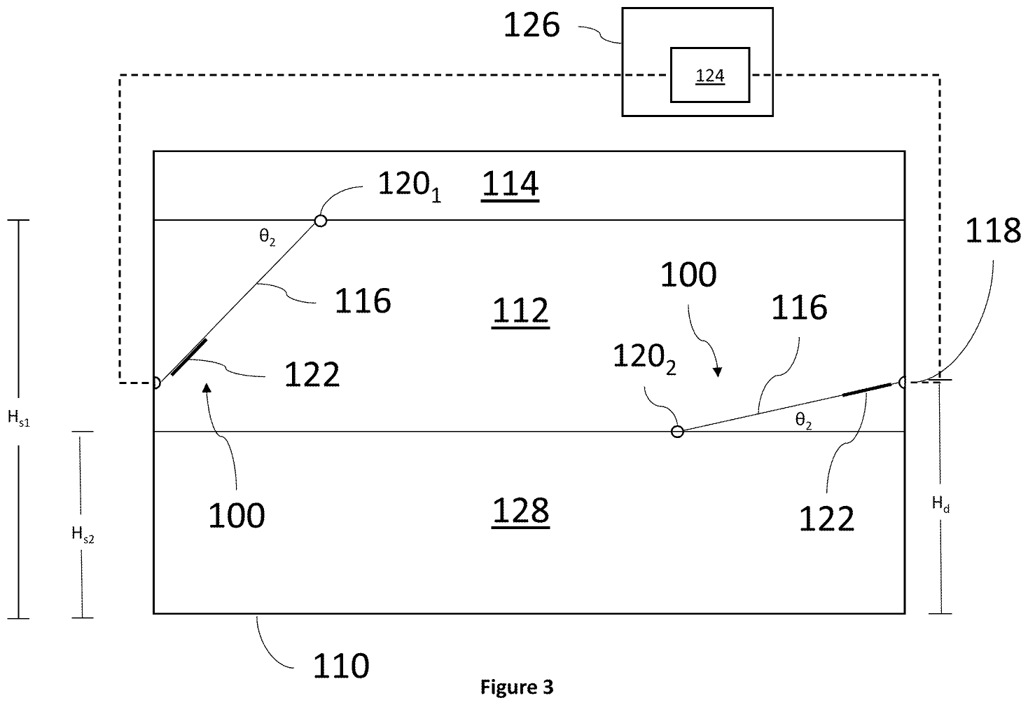

FIG. 3 is a schematic view of an implementation of the system 100 being used in a tank 110 that contains three fluids 112, 114, 128 with different densities. In the illustrated implementation, the system 100 is configured to track the surface between water 128 and the oil 112 and the surface between the oil 112 and the natural gas. The system includes two lever arms 116, two hinges 118, two floats 120, and two inclinometers 122. Although the other pairs of components can be the same, the floats 1201 and 1202 have different densities. In the illustrated implementation, both inclinometers 122 are in communication with the same processor 124 of the SCADA system 126. In some implementations, the inclinometers 122 are in communication with different processors.

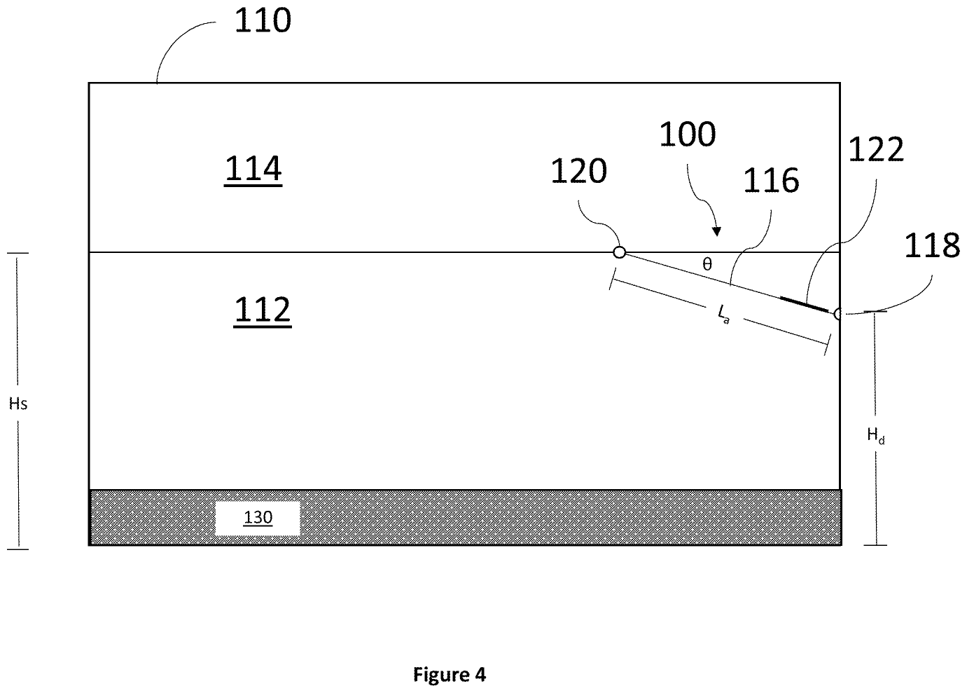

FIG. 4 illustrates how the presence of sediments can introduce error into level measurements made using the system 100. The illustrated scenario is similar to that shown in FIG. 1 except the fluid stored in the tank 110 includes a significant amount of sediments. Over time, the natural gas 114 separates from and rises above the oil 112 while the sediments 130 settle to the bottom of the tank 110. The system 100 still tracks the location of the interface between the oil 112 and the natural gas 114. However, the height of this interface is measured from the bottom of the tank 110 rather than from the top of the sediments 130. In most cases, the sediments will be saturated with fluid which means that the surface height should be measured from the bottom of the tank regardless if there is sediment or not. However; the volume accuracy will be affected by the amount of the sediments.

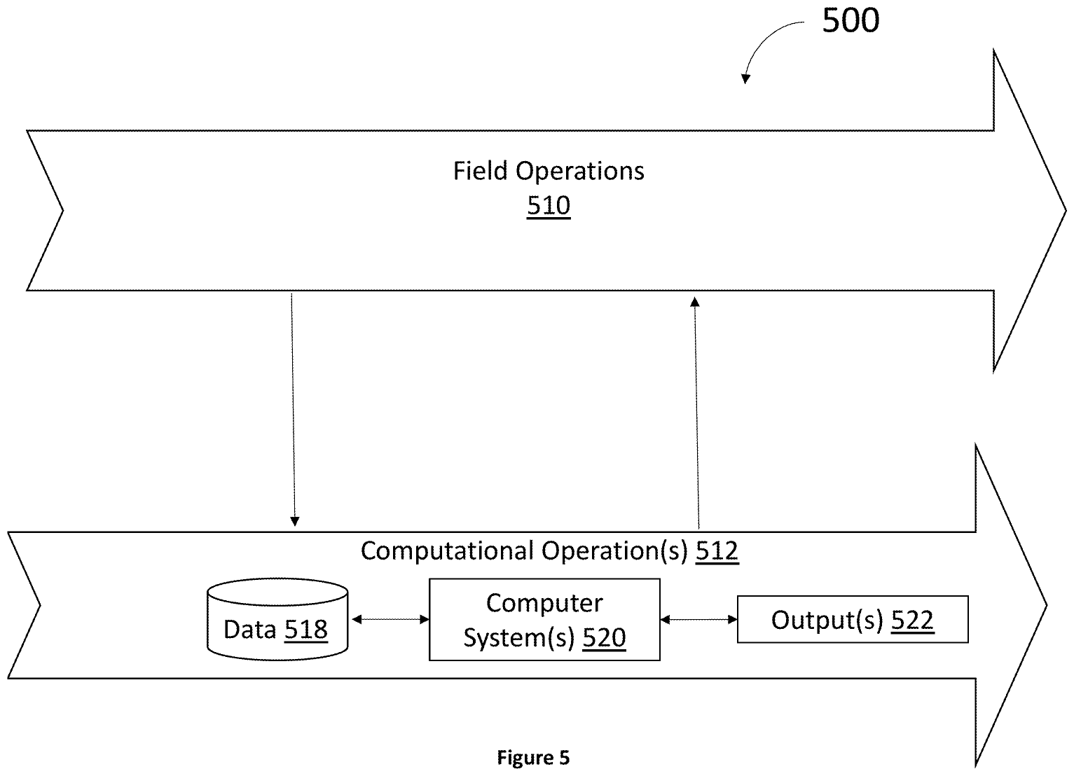

FIG. 5 illustrates hydrocarbon production operations 500 that include both one or more field operations 510 and one or more computational operations 512, which exchange information and control exploration for the production of hydrocarbons. In some implementations, outputs of techniques of the present disclosure can be performed before, during, or in combination with the hydrocarbon production operations 500, specifically, for example, either as field operations 510 or computational operations 512, or both.

Examples of field operations 510 include forming/drilling a wellbore, hydraulic fracturing, producing through the wellbore, injecting fluids (such as water) through the wellbore, to name a few. In some implementations, methods of the present disclosure can trigger or control the field operations 510. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 510 and responsively triggering the field operations 510 including, for example, generating plans and signals that provide feedback to and control physical components of the field operations 510. Alternatively or in addition, the field operations 510 can trigger the methods of the present disclosure. For example, implementing physical components (including, for example, hardware, such as sensors) deployed in the field operations 510 can generate plans and signals that can be provided as input or feedback (or both) to the methods of the present disclosure.

Examples of computational operations 512 include one or more computer systems 520 that include one or more processors and computer-readable media (e.g., non-transitory computer-readable media) operatively coupled to the one or more processors to execute computer operations to perform the methods of the present disclosure. The computational operations 512 can be implemented using one or more databases 518, which store data received from the field operations 510 and/or generated internally within the computational operations 512 (e.g., by implementing the methods of the present disclosure) or both. For example, the one or more computer systems 520 process inputs from the field operations 510 to assess conditions in the physical world, the outputs of which are stored in the databases 518. For example, seismic sensors of the field operations 510 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 512 where they are stored in the databases 518 and analyzed by the one or more computer systems 520.

In some implementations, one or more outputs 522 generated by the one or more computer systems 520 can be provided as feedback/input to the field operations 510 (either as direct input or stored in the databases 518). The field operations 510 can use the feedback/input to control physical components used to perform the field operations 510 in the real world.

For example, the computational operations 512 can process the seismic data to generate three-dimensional (3D) maps of the subsurface formation. The computational operations 512 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 512 to process new information about the formation and control the drilling to adjust to the observed conditions in real-time.

The one or more computer systems 520 can update the 3D maps of the subsurface formation as information from one exploration well is received and the computational operations 512 can adjust the location of the next exploration well based on the updated 3D maps. Similarly, the data received from production operations can be used by the computational operations 512 to control components of the production operations. For example, production well and pipeline data can be analyzed to predict slugging in pipelines leading to a refinery and the computational operations 512 can control machine operated valves upstream of the refinery to reduce the likelihood of plant disruptions that run the risk of taking the plant offline.

In some implementations of the computational operations 512, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of embodiments of these systems and methods have been described. Nevertheless, it will be understood that various modifications may be made without departing from the spirit and scope of this disclosure. For example, although the system 100 uses the hinge 118 to attach the lever arm 116 to the inner wall of the container 110, some systems use other attachment mechanisms.

Accordingly, other embodiments are within the scope of the following claims.

What is claimed is:

1. A system for measuring liquid levels in a tank, the system comprising:
a lever arm pivotably attached to an inner wall of the tank at a first end of the lever arm;
a float mounted on the lever arm at a location spaced apart from the first end of the lever arm;
an inclinometer mounted on a lever arm to measure an angle of the lever arm relative to horizontal; and
a processor operable to calculate a height of a surface of the fluid in the container based on the angle of the lever arm relative to horizontal.

2. The system of claim 1, wherein the float is mounted on a second end of the lever arm opposite the first end of the lever arm.

3. The system of claim 1, further comprising a hinge attaching the lever arm to the inner wall of the container.

4. The system of claim 1, wherein the lever arm comprises copper.

5. The system of claim 1, wherein the lever arm has a length between 50% and 100% of a height of the tank.

6. The system of claim 5, wherein the lever arm is attached to the inner wall of the tank at half the height of the tank.

7. The system of claim 1, wherein the float is configured to float on the surface of oil.

8. The system of claim 7, wherein the float has a density between 1 and 790 kilograms/square meter (kg/m²).

9. The system of claim 1, wherein the float is configured to float at an interface between oil and water.

10. The system of claim 9, wherein the float has a density between 790 and 1000 kilograms/square meter (kg/m²).

11. The system of claim 1, wherein the float is one of a plurality of floats having different densities and the floats are removably attached to the lever arm.

12. The system of claim 1, wherein the processor is operable to calculate a height (Hₛ) of the float in the tank based on the angle of the lever arm using the equation Hₛ=Hₚ−(Lₐ×sin θ) where Hₚ is the height at which the lever arm is attached to the tank, Lₐ is a length of the lever arm, and θ is the angle of the lever arm relative to horizontal.

13. The system of claim 1, further comprising a Supervisory Control and Data Acquisition (SCADA) system in electronic communication with the inclinometer.

14. The system of claim 13, wherein the processor is part of the SCADA system.

15. The system of claim 14, wherein the SCADA system is operable to control at least one pump associated with the tank.

16. The system of claim 1, wherein the lever arm is one of a plurality of lever arms pivotably attached to the inner wall of the tank and the float is one of a plurality of floats, each float mounted on one of the plurality of lever arms, and the inclinometer is one of a plurality of inclinometers.
